(19) United States
(12) Patent Application Publication
(10) Pub. No.: US 2008/0115747 A1
(43) Pub. Date: May 22, 2008

(54) COOLANT CONTROLLER FOR AN INTERNAL COMBUSTION ENGINE

(75) Inventors: W. Bryan Snyder, Westland, MI (US); Robert Z. Olszewski, Glen Ellyn, IL (US); Martin R. Zielke, Lockport, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/555,272

(22) Filed: Oct. 31, 2006

(51) Int. Cl. F01P 1/06; F02M 25/07

(52) U.S. Cl. 123/41.31; 123/568.12

(57) ABSTRACT

A cooling system (100) for an internal combustion engine (102) includes a fluid pump (106) having an inlet (138) and an outlet (146), a plurality of engine components having a plurality of fluid passages (118, 120) formed therein, a radiator (104), and at least one exhaust gas recirculation (EGR) cooler (108). A fluid controller (500) fluidly interconnects the fluid pump (106), the fluid passages (118, 120) in the plurality of engine components, the radiator (104), and the at least one EGR cooler (108). The fluid controller (500) includes a pressure regulating thermostat (PRT) (502) having a first inlet (514), a second inlet (518), and a first outlet (516), and also includes an EGR mixing valve (EMV) (504) that has an additional first inlet (528), an additional second inlet (530), and an additional first outlet (532).

### FIELD OF THE INVENTION

This invention relates to internal combustion engines, including but not limited to coolant controllers, or thermostats, used in cooling systems of internal combustion engines.

### BACKGROUND OF THE INVENTION

Internal combustion engines include crankcases having a plurality of cylinders. The cylinders contain pistons whose reciprocating motion due to combustion events is transferred through a crankshaft to yield a torque output of the engine. Heat generated during operation of the engine is typically removed therefrom by a combination of oil and/or coolant based cooling systems. Such systems, and typically coolant based systems, require flow control of a coolant flow depending on the temperature and/or pressure thereof. For example, during cold conditions such as when the engine is initially started, most heat generated by the engine is retained within the engine to help the engine warm up to normal operating temperature. At times when the engine is warm, the heat generated within the engine may be removed from the engine to avoid an overheating condition.

Typical cooling systems circulate a flow of coolant fluid, e.g., oil or coolant, within the engine. When a temperature or pressure of the coolant fluid increases, a portion or the entire flow is selectively or controllably routed to a radiator where heat is expelled to the environment, thus cooling the flow before it returns to the engine.

A cooling system of an engine is often used for more than just cooling the engine components during operation. For example, some engines have exhaust gas recirculation (EGR) systems that use a portion of the engine's coolant flow in a heat exchanger that removes heat from a flow of exhaust gas that is recirculated from an exhaust system into an intake system of the engine. Sometimes, a temperature requirement for the temperature of the cooling fluid in the EGR system may be different than the temperature of the cooling fluid circulating through the rest of the engine. One such condition, for instance, may be during engine warm up. In such a condition, the engine may require warmer coolant circulating therethrough to aid in warming up the engine, yet the EGR system may require cooler coolant running therethrough to lower the engine's emissions.

Prior attempts have been made to address such issues. One method used in the past is the addition of temperature sensors throughout the engine that communicate temperature information for coolant flows through different locations and systems of the engine. This temperature information can be analyzed in an engine controller that decides whether portion of the coolant flow going through an engine system, for example the EGR system, should be diverted to a radiator, while a remaining flow circulating through the rest of the engine bypasses the radiator. Once such a determination has been made, electronic coolant valves and auxiliary coolant passages are be used to divert a desired portion of the flow from the engine so it can pass through the radiator.

This and other methods used in the past are partially effective in accomplishing effective temperature control for various engine systems, but are costly and complicated to implement. Moreover, dependence of coolant flow on electronic valves can make an engine system more prone to damage due to overheating should any electronic valves malfunction or fail.

Accordingly, there is a need for an improved cooling system configuration for an internal combustion engine that is simple to implement, cost effective, and that uses simple and robust components.

### SUMMARY OF THE INVENTION

A cooling system for an internal combustion engine includes a fluid pump having an inlet and an outlet, a plurality of engine components having a plurality of fluid passages formed therein, a radiator, and at least one exhaust gas recirculation (EGR) cooler. A fluid controller is in fluid communication with the fluid pump, the fluid passages in the plurality of engine components, the radiator, and the at least one EGR cooler. The fluid controller includes a pressure regulating thermostat (PRT) having a first inlet, a second inlet, and a first outlet. An EGR mixing valve (EMV) has an additional first inlet, an additional second inlet, and an additional first outlet.

### BRIEF DESCRIPTION OF THE DRAWINGS

FIG. 1 is a block diagram of a cooling system for an internal combustion engine in accordance with the invention.

FIG. 2 is a block diagram of the cooling system of FIG. 1 operating under a hot-engine/high temperature mode of operation, in accordance with the invention.

FIG. 3 is a block diagram of the cooling system of FIG. 1 operating under a warm-up/low temperature mode of operation, in accordance with the invention.

FIG. 4 is a block diagram of the cooling system of FIG. 1 operating under a transitional or an intermediate engine temperature mode of operation, in accordance with the invention.

FIG. 5 is a block diagram for a combined coolant controller in accordance with the invention.

FIGS. 6A and 6B are outline views from different perspectives of one embodiment of a coolant controller in accordance with the invention.

FIG. 7 is a cross-section view through the embodiment for the coolant controller of FIGS. 6A and 6B.

FIG. 8 is a flowchart for a method of selectively cooling an internal combustion engine during various modes of operation, in accordance with the invention.

### DESCRIPTION OF A PREFERRED EMBODIMENT

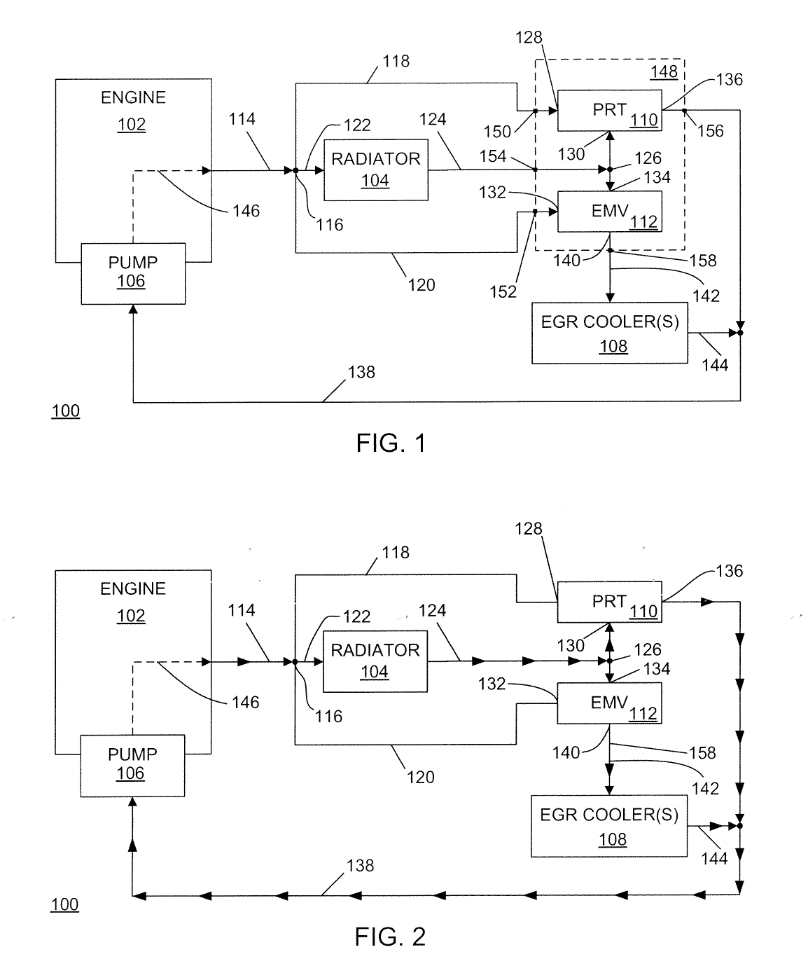

The following describes an apparatus for and method of controlling a flow of coolant based on temperature and/or pressure between different systems of an internal combustion engine. A block diagram of a cooling system 100 is shown in FIG. 1. The cooling system 100 includes an engine 102, a radiator 104, a pump 106, one or more exhaust gas recirculation (EGR) cooler(s) 108, a pressure regulating thermostat (PRT) 110, and an EGR mixing valve (EMV) 112.

The engine 102 has a coolant supply passage 114 that is connected to a first coolant distribution junction 116. The junction 116 is connected to a first supply passage 118 that is connected to the PRT 110, a second supply passage 120 that is connected to the EMV 112, and to a third supply passage 122 that is connected to the radiator 104. A radiator outlet passage 124 may be connected to a junction 126.

The PRT 110 has a first inlet 128 connected to the first supply passage 118 that is connected to the engine 102, and a second inlet 130 connected to the junction 126 that is connected to the radiator 104. The EMV 112 has a first inlet 132 connected to the second supply passage 120 that is connected to the engine 102, and a second inlet 134 connected to the junction 126 that is connected to the radiator 104. The junction 126 is optional because the second inlet 130 of the PRT 110 and the second inlet 134 of the EMV 112 may be separately connected to the outlet passage 124 of the radiator 104 at different locations.

An outlet 136 of the PRT 110 is connected to a pump return passage 138 that is connected to the pump 106. An outlet 140 of the EMV 112 is connected to an EGR supply passage 142. The EGR supply passage 142 is connected to the one or more EGR cooler(s) 108. An EGR return passage 144 connects the one or more EGR cooler(s) 108 with the pump return passage 138. A pump outlet passage 146, shown in dotted line, connects the pump 106 with the coolant supply passage 114 internally in the engine 102.

The PRT 110 and EMV 112 may advantageously be combined in a single housing. In this case, a single coolant control assembly 148 includes the PRT 110 and EMV 112 and has a PRT engine-input port 150, an EMV engine-input port 152, a combined radiator-inlet port 154, a pump return port 156, and an EGR supply outlet port 158.

A block diagram of the cooling system 100 operating during a hot-engine/high-temperature mode of operation is shown in FIG. 2. Arrows denote a flow of coolant between components of the cooling system 100. Under this mode of operation, a flow of coolant exits the engine 102 through the coolant supply passage 114 and enters the radiator 104. The first and second supply passages 118 and 120 are dead-headed, or substantially blocked from flow of fluid therethrough, by the PRT 110 and EMV 112 respectively. A portion of the flow of coolant enters the PRT 110 through its second inlet 130, and a remaining portion of the flow of coolant enters the EMV 112 through its second inlet 134. The flow of coolant passing through the radiator 124 is advantageously cooled. The portion of the flow of coolant that enters the PRT 110 is routed to the outlet 136 and into the pump return passage 138. The remaining portion of the flow of coolant that enters the EMV 112 is routed to the outlet 140 thereof, and pass through the one or more EGR cooler(s) 108 before it too enters the pump return passage 138.

In this high temperature mode of operation, the pump 106 impels the re-combined portions of the flow of coolant in the pump return passage 138 through the engine 102 and back out through the coolant supply passage 114. During the normal mode of operation, the cooling system 100 is capable of removing heat from the engine 102 and the one or more EGR cooler(s) 108, and rejecting the heat to the environment through the radiator 104. The PRT 110, which functions as a thermostat, fluidly connects the second inlet 130 thereof with the outlet 136 thereof, and substantially fluidly blocks the first inlet 128 thereof which is exposed to warm coolant exiting the engine 102 through the coolant supply passage 114. Similarly, the EMV 112, which may also function as a thermostat, fluidly connects the second inlet 134 thereof with the outlet 140 thereof, and substantially fluidly blocks the first inlet 132 thereof which is also exposed to warm coolant exiting the engine 102 through the coolant supply passage 114.

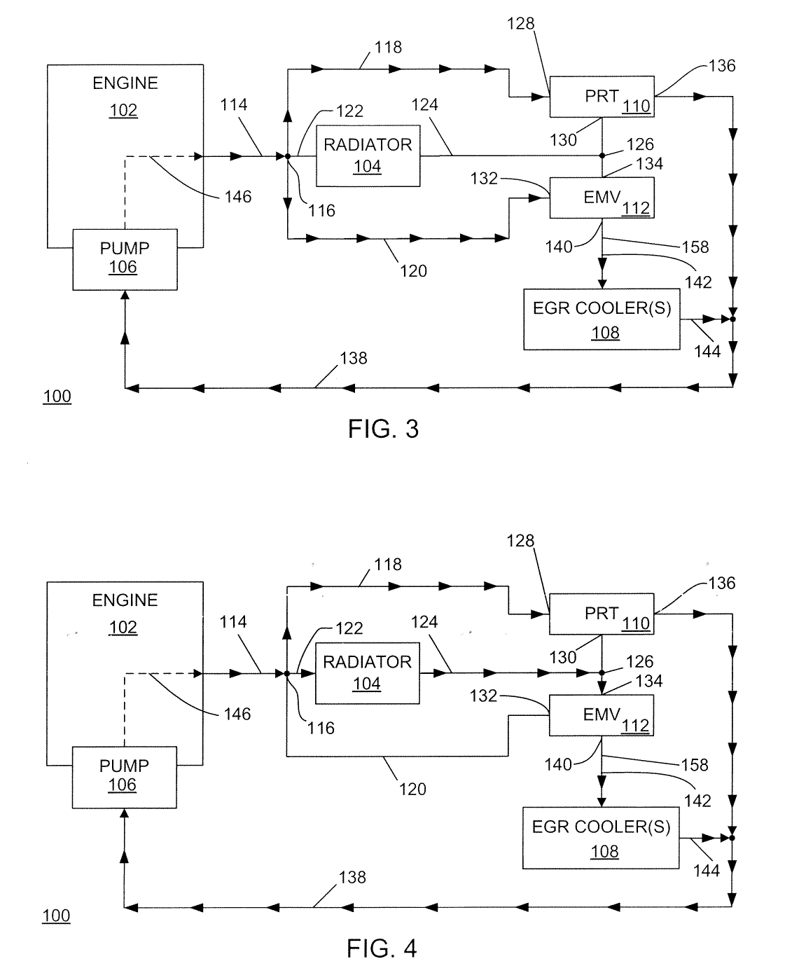

A block diagram of the cooling system 100 operating during a warm-up/low temperature mode of operation is shown in FIG. 3. Arrows denote a flow of coolant between components of the cooling system 100. A flow of coolant exits the engine 102 through the coolant supply passage 114. A first portion of the flow of coolant enters the first supply passage 118, and a remaining portion of the flow of coolant enters the second supply passage 120. The third supply passage 122 that is connected to the radiator 104 may be dead-headed, or substantially blocked for flow of fluid therein, by both the PRT 110 and EMV 112.

The portion of the flow of coolant in the first supply passage 118 enters the PRT 110 through the first inlet 128 thereof, and exits through its outlet 136 into the pump return passage 138. Similarly, the remaining portion of the flow of coolant in the second supply passage 120 enters the EMV 112 through the first inlet 134 thereof, exits through the outlet 140 thereof, passes through the one or more EGR cooler(s) 108, and also enters the pump return passage 138 where it mixes with the portion of the flow of coolant coming from the PRT 110 to yield a recombined flow of coolant. The recombined flow of coolant in the pump return passage 138 is returned to the pump 106 where it is impelled and passed through the engine 102 and back out the coolant supply passage 114. In the low temperature mode of operation, the PRT 110 is arranged to fluidly connect the first inlet 128 with the outlet 136 thereof, while fluidly blocking its second inlet 130. Also, the EMV 112 fluidly connects the first inlet 132 with the outlet 140 thereof, while fluidly blocking its second inlet 134.

A block diagram of the cooling system 100 operating during a transitional or an intermediate engine temperature mode of operation is shown in FIG. 4. Arrows denote a flow of coolant between components of the cooling system 100. In this transitional mode of operation, the engine 102 is not yet sufficiently warm, yet emissions requirements require cooling of exhaust gas in the one or more EGR cooler(s) 108 that is comparable to the cooling during the high temperature mode of operation. In this case, a flow of coolant exits the engine 102 through the coolant supply passage 114. A first portion of the flow of coolant from the coolant supply passage 114 enters the first supply passage 118, and a remaining portion of the flow of coolant enters the radiator 104 through the third supply passage 122. The second supply passage 120 that is connected to the EMV 112 is dead-headed, or substantially blocked for flow of fluid therein by the EMV 112 through its first inlet 132.

The portion of the flow of coolant in the first supply passage 118 enters the PRT 110 through the first inlet 128 thereof, and exits through its outlet 136 into the pump return passage 138. In the case where the PRT 110 has a pressure regulating feature associated therewith, that is arranged to block flow through the first inlet 128 if a pressure at the first inlet 128 is less than a pressure at its outlet 136 by a predetermined magnitude, then there will be little to no flow passing through the first supply passage 118 into the PRT 110. The remaining portion of the flow of coolant that passes through the radiator 104 is cooled before entering the EMV 112 through its second inlet 134, and exits the EMV 112 through its outlet 140. The remaining portion of the flow of coolant, that has undergone additional cooling as compared to the first portion of the flow of coolant passing through the PRT 110, passes through the one or more EGR coolers 108 thus providing the required cooling of exhaust gas that is passing therethrough. The remaining portion of the flow of coolant exits the one or more EGR cooler(s) 108 and is routed to the pump return passage 138 where it mixes with the first portion of the flow of coolant from the PRT 136 to be returned to the pump 106. The pump 106 impels the flow of coolant in the pump return passage 138 through the engine 102 and back out the coolant supply passage 114.

Operation of the cooling system 100 under the low-temperature, high-temperature, or intermediate-temperature modes of operation is advantageous because it enables fast warm-up of the engine 102 at low temperatures without compromise to a required cooling effectiveness of the one or more EGR cooler(s) 108. The PRT 110 may be a thermostat that is not prone to temperature fluctuation instabilities. For examples of such thermostats, one can refer to U.S. Pat. No. 5,727,729 by Hutchins, published on Mar. 17, 1998, and titled “Combined Bypass and Thermostat Assembly,” whose contents are incorporated herein in their entirety by reference, and that teaches a bypass and thermostat assembly that includes means to prevent relatively cold coolant from entering the thermostat assembly and impinging upon a temperature sensitive valve actuating means. An additional example can also be seen in U.S. Pat. No. 5,787,845 also by Hutchins, published on Aug. 4, 1998, titled “Combined Bypass and Thermostat Assembly,” the contents of which are incorporated herein in their entirety, and that teaches a combined thermostat and bypass valve that is arranged to restrict bypass flow by means of a spring-loaded bypass valve operating at a bypass delivery port to ensure an adequate supply of hot engine coolant to a heater circuit at low engine speeds.

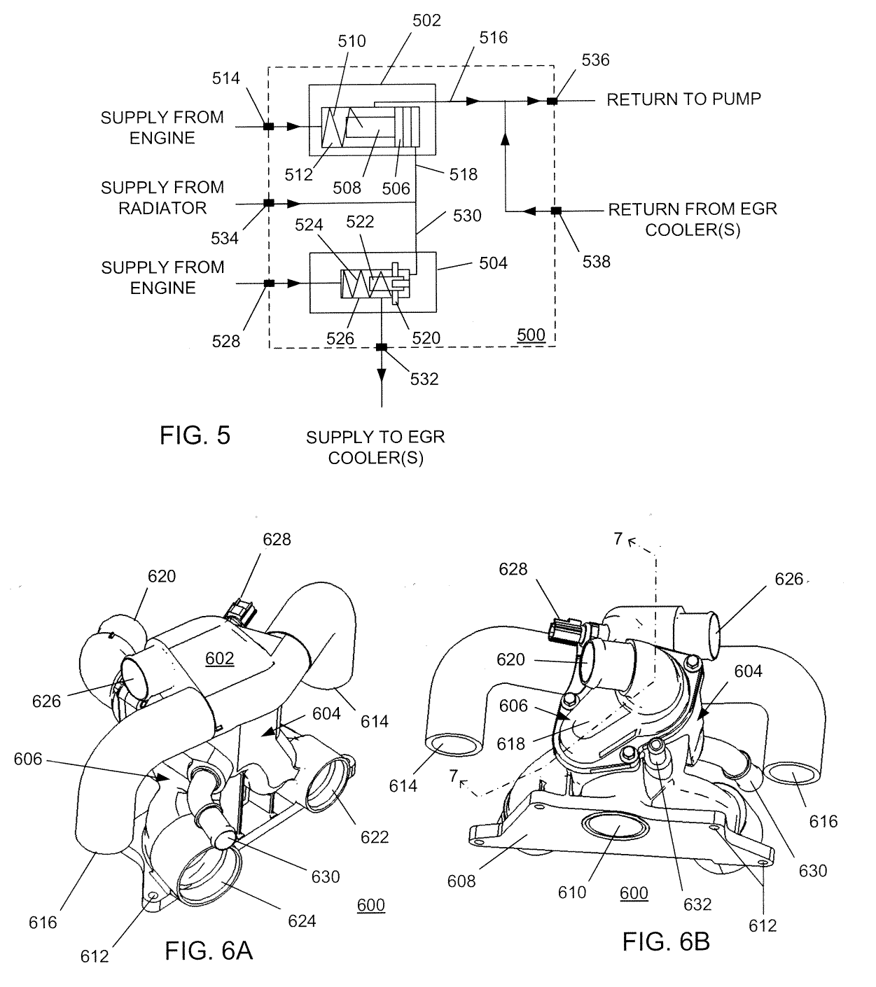

One may advantageously combine the PRT and EMV into one housing for use as part of a cooling system for an internal combustion engine. A block diagram for a combined coolant controller 500 is shown in FIG. 5. The controller 500 includes a PRT portion 502 and an EMV portion 504. The PRT portion 502 houses a thermally and/or pressure-responsive valve that includes a plate 506, a thermal actuator 508, and a return spring 510. The PRT portion 502 includes a transfer chamber 512 that is fluidly open to a first inlet 514. A first outlet 516 is connectable to either the first inlet 514 and/or to a second inlet 518 depending on a position of the plate 506. The position of the plate 506 within the transfer chamber 512 is controlled by a position of the thermal actuator 508 that is connected to the plate 506, as well as a net pressure of coolant around the plate 506. The position of the thermal actuator 508 depends on a temperature of coolant in the chamber 512 and on a reaction force of the spring 510, as is known.

The EMV portion 504 houses a thermally responsive valve that includes a stopper 520 that is connected to an additional thermal actuator 522. An additional return spring 524 is arranged to act on the stopper 520. The stopper 520, additional thermal actuator 522, and additional return spring 524, are included in a mixing chamber 526 formed in the EMV portion 504 of the controller 500. Coolant may enter the mixing chamber 526 from either a first inlet 528 or a second inlet 530. An outlet 532 for coolant from the mixing chamber 526 is formed in the EMV portion 504. Coolant exiting the mixing chamber 526 may advantageously be coolant that entered the chamber 526 either from the first inlet 528, the second inlet 530, or a mixture of coolant that entered the chamber 526 from both the first inlet 528 and the second inlet 530. A composition of coolant at the outlet 532 of the controller 500 depends on a temperature of coolant within the mixing chamber 526.

A position of either the thermal actuator 508 in the PRT portion 502 or the additional thermal actuator 522 in the EMV portion 504 may be correlated differently to the temperature of coolant in either the transfer chamber 512 of the PRT portion 502 or the mixing chamber 526 of the EMV portion 504 to advantageously enable operation during an intermediate-temperature mode of operation as described above.

The second inlet 518 of the PRT portion 502 and the second inlet 530 of the EMV portion 504 may advantageously be fluidly connected to each other and to an additional external inlet 534 of the controller 500. The controller 500 has a first outlet 536 that is connected to an inlet of a pump (not shown) as described above. Moreover, other coolant passages, such as an EGR cooler return inlet 538, or a heater supply and/or return passage(s) (not shown), may advantageously be incorporated in the controller 500 to facilitate more efficient and robust coolant circuit integration and connections. Integration of the PRT portion 502, EMV portion 504, and other fluid passages into the coolant controller 500 is advantageous as compared to having such components individually be part of a cooling system for an engine, because the performance of not only each of the PRT and EMV is improved, but the performance of the entire cooling system is improved by reducing lag time between temperature transitions, reducing overall system pressure losses, and improving a stability of the system, mostly due to the proximity of the PRT and EMV to each other, but also, due to proximity and availability of various coolant flows, at different temperatures, in the immediate vicinity of the both the thermal actuator 508 of the PRT portion 502 and the additional thermal actuator 522 of the EMV portion 504.

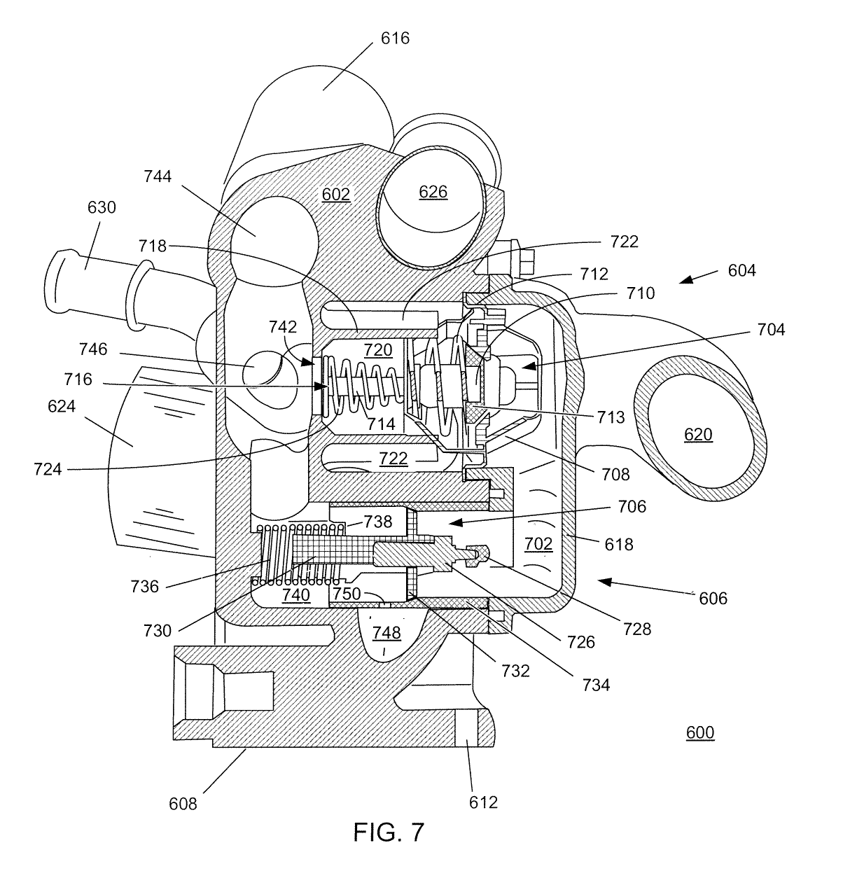

Various outline views from different perspectives of one embodiment of a coolant controller 600 are shown in FIGS. 6A and 6B, and a cross-section view of the same embodiment of the controller 600 is shown in FIG. 7. The controller 600 includes a housing 602. The housing 602 may be made of metal and be formed by a casting operation, followed by a number of machining operations that define various features thereof. The housing 602 has a PRT portion 604, an EMV portion 606, a mounting flange 608 having a coolant inlet opening 610, and a plurality of mounting bosses 612. The controller 600 has a right cylinder head coolant supply passage 614, and a left bank cylinder head coolant supply passage 616. A radiator inlet housing 618 is connected to the housing 602 and includes a radiator inlet opening 620. The controller 600 further includes an EGR cooler supply opening 622 and an EGR cooler return opening 624 formed in the housing 602. A radiator supply opening 626 is formed in the housing 602 and is located close to a coolant temperature sensor 628 that is connected to the housing 602. Additional openings that may advantageously be incorporated in the controller 600 include a heater-supply opening 630, and a de-gas opening 632.

Moving now to the cross-section view shown in FIG. 7, the radiator inlet housing 602 has an internal distribution cavity 702 that fluidly connects a first inlet opening 704 of the PRT portion 604 and a first inlet 706 of the EMV portion 606 with the radiator inlet opening 620. The PRT portion 604 includes a PRT valve body 708 that is connected to the housing 602 and forms the first opening 704. The PRT valve body includes a thermal actuator 710 that is surrounded by a return spring 712. A thermostat poppet 713 is connected to the actuator 710 and the spring 712, and is arranged to block the first inlet opening 704 intermittently. A linkage arm 714 connects the thermal actuator 710 and has an additional poppet valve 716 connected to a distal end thereof. A wall 718 that is formed in the housing 602 separates an inner PRT cavity 720 from an outer PRT cavity 722. The wall 718 surrounds a portion of the linkage 714. A pressure regulation spring 724 s surround the linkage 714 and rests against the poppet 716 on one side, and the PRT valve body 708 on another side.

The EMV portion 606 includes an EMV thermal actuator 726 that is connected to the housing 602 via a protrusion 728 that lies within the first inlet 706. The thermal actuator 726 is connected to a linkage 730 that has a poppet valve 732 formed thereon. A sleeve 734 may advantageously be inserted in the housing 602 and surround portions of the thermal actuator 726 and the linkage 730 while providing a seat for the poppet 732. A return spring 736 is located between a section of the housing 602 and a shoulder 738 of the linkage 730 to provide a return for the linkage 730 that acts against the thermal actuator 726 to return the poppet 732 to a closed position. The spring 736 and linkage 730 are at least partially located in a mixing cavity 740 that is formed in the housing 602 in the EMV portion 606 thereof.

The controller 600 has a number of openings and passages that advantageously fluidly connect various components and cavities to each other in a selective manner depending on a temperature and/pressure of coolant passing therethrough. The PRT portion 604 has a first inlet opening 704 as described. Coolant entering the PRT portion 604 from the inlet opening 704 is coolant coming into the controller 600 from the radiator inlet 620, which is cooled coolant that has passed through a radiator of a cooling system (described above). The PRT portion 604 has an additional inlet opening 742, which may be intermittently blocked by the poppet 716 that is connected to the linkage 714. Coolant entering through the first inlet 704 and/or the additional inlet 742 exits the PRT portion 604 through the cavity 722 that is in fluid communication with the coolant inlet opening 610 to return to a pump of the engine (not shown).

During operation of an engine, a fluid pump supplies a flow of coolant to various engine components, for example, cylinder heads, crankcase, various coolers including an oil cooler, and so forth. Coolant returning from these engine components enters the controller 600 through the openings 614 and 616. While in the controller 600, the flow of coolant from various openings combines in a gallery 744 that is formed by the housing 602. Coolant in the gallery 744 is warm because it has passed through and removed heat from various engine components since leaving the pump. The gallery 744 is in fluid communication with a heater supply port 746 that fluidly communicates with the heater-supply opening 630 to supply warm coolant thereto when a heater circuit (not shown) is active. The gallery 744 is also in fluid communication with the mixing cavity 740.

Coolant entering the mixing cavity 740 passes over the thermal actuator 726 in the EMV portion 606, and exits the controller through an EGR cooler supply passage 748 that is in fluid communication with the EGR cooler supply opening 622. Coolant being passed into the EGR cooler supply passage 748 from the mixing cavity 740 during a low-temperature mode of operation passes through an opening 750 that is formed in the sleeve 734 and that fluidly connects the mixing chamber 740 with the EGR cooler supply passage 748 depending on a position of the poppet 732. When a temperature of coolant in the gallery 744 exceeds an opening temperature or an actuation temperature of the thermal actuator 726 in the EMV portion 606, the actuator 726 will expand thus pushing the poppet 732 against the spring 736 thus fluidly opening or unblocking the first inlet 706 of the EMV portion 606 to allow a flow of cooled coolant coming from the radiator that is in the internal distribution cavity 702 to pass through the first inlet 706 and enter the mixing chamber 740. Once in the mixing chamber 740, the cooled coolant from the first inlet 706 will mix with the warmer coolant from the gallery 744 to yield a mixture that has a lower temperature than the coolant in the gallery 744, and the mixture will pass through the opening 750 and enter the EGR cooler supply passage 748.

A temperature of the mixture of coolant in the EGR cooler supply passage 748 will be somewhere between the warm temperature of the coolant in the gallery 744 and the cool temperature of the coolant in the internal distribution cavity 702. When the poppet 732 is less open, the coolant in the EGR cooler supply passage 748 will be warmer, and when the poppet 732 is more open, the coolant in the EGR cooler supply passage 748 will be cooler.

Moving now to the PRT portion 604, the poppet 716 may be actuated during operation of the engine depending on a pressure of the coolant in the gallery 744. At times when the engine is warming up but there is no load demanded thereof and the engine is operating at low revolutions, a pressure of the coolant in the gallery 744 is low, or less than about 32 kPa, and the poppet 716 fluidly blocks flow through the additional opening 742. The thermostat poppet 713 may also be closed. At times when the engine is cold but a vehicle is being driven, causing the engine to operate at higher revolutions, the pressure of coolant in the gallery 744 will typically increase to a higher pressure, for example a pressure of more than about 32 kPa, and the poppet 716 will open against the spring 714 to allow a flow of coolant from the gallery 744 to enter the inner PRT cavity 720, pass over the PRT thermal actuator 710 into the outer PRT cavity 722, and exit the controller 600 to return to the pump through the pump inlet opening 610. The pressure regulated PRT poppet 716 may remain open at a variable amount depending upon a pressure of the coolant in the gallery 744.

At times when the engine is warm, i.e., when a temperature of the coolant entering the inner PRT cavity 720 through the additional opening 742 is sufficiently high to cause the PRT thermal actuator 710 to expand, the thermostat poppet 713 may move to a more open position and unblock the first inlet 704, thus allowing cooled coolant from the internal distribution cavity 702 to enter partly the inner PRT cavity 720 and primarily the outer PRT cavity 722, and exit the controller 600 through the pump inlet opening 610 as described above.

Use of the controller 600 is advantageous to the operation of an engine because independent control of a temperature and pressure of coolant supplied to engine components and separately to one or more EGR cooler(s) is enabled. By combining the PRT and EMV portions of a cooling system into a single housing, a lag time is decreased for changes to fluid flows between various engine systems, and stability in the operation of various valves, for example the motion of poppets 716, 712, and 732, is accomplished. The opening temperatures for the EMV poppet 732 and the PRT thermostat poppet 713 may advantageously be different.

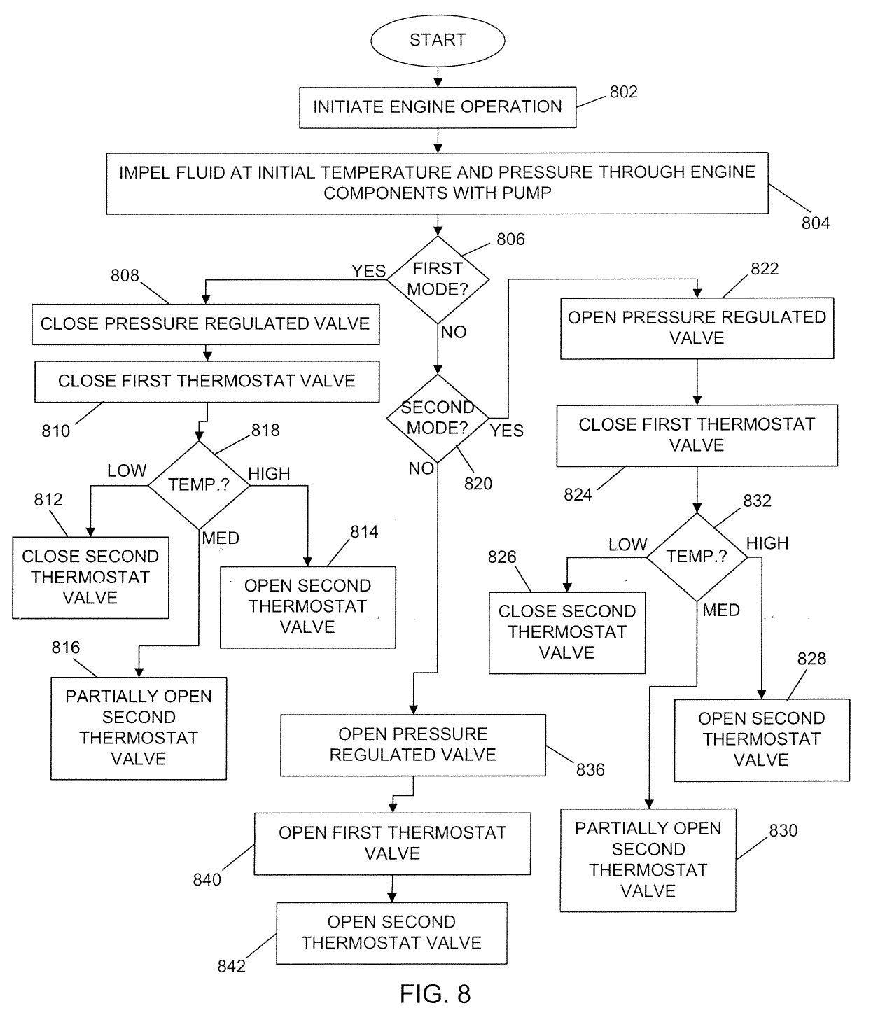

A flowchart for a method of cooling an internal combustion engine during various modes of operation is shown in FIG. 8. An operation of an engine having a fluid pump for pumping a cooling fluid is initiated at step 802. The pump impels a flow of fluid having an initial temperature and a first pressure through various engine components at step 804. A coolant controller routes at least a portion of the flow of cooling fluid differently depending on a temperature and pressure of the coolant fluid. A first mode of operation is selected at times when the engine is warming-up and operates close to an idle condition at step 806.

While the engine operates under the first mode, a pressure regulated valve is closed to block a flow of coolant fluid returning from the engine from reaching a thermostat, at step 808. A first thermostat valve is closed to block the flow of coolant fluid returning from the engine from entering a radiator, at step 810. A second thermostat valve is closed and routes a portion of the flow of coolant returning from the engine to an EGR cooler supply passage at step 812 when a coolant temperature is low, or may alternatively be fully open and route a portion of a flow of fluid from the radiator to the EGR cooler supply passage at step 814 when the coolant temperature is high, or may alternatively be partially open and mix a portion of the flow of coolant returning from the engine with a portion of a flow of fluid from the radiator, to yield a mixture, and route the mixture to the EGR cooler supply passage at step 816 when the coolant temperature is intermediate. A selection between steps 812, 814, and 816 is be made at step 818 based on a temperature of the flow of cooling fluid returning from the engine.

A second mode of operation may be selected at times when the engine is operating without having fully warmed up, but is not close to an idle condition, at step 820. While the engine operates under the second mode, a pressure regulated valve is be partially opened to allow at least a portion of the flow of coolant fluid returning from the engine to reach the thermostat at step 822. A first thermostat valve is closed to block the flow of coolant fluid returning from the engine from entering the radiator at step 824. The second thermostat valve is closed and routes a portion of the flow of coolant returning from the engine to an EGR cooler supply passage at step 826 when coolant temperature is low, or may alternatively be open and route a portion of a flow of fluid from the radiator to the EGR cooler supply passage at step 828 when coolant temperature is high, or may alternatively be partially open and mix a portion of the flow of coolant returning from the engine with a portion of a flow of fluid from the radiator, to yield a mixture, and route the mixture to the EGR cooler supply passage at step 830 when the coolant temperature is intermediate. A selection between steps 826, 828, and 830 is made at step 832 based on a temperature of the flow of cooling fluid returning from the engine.

A third mode of operation may be a normal of default mode of operation for an engine that is not operating under the first or second modes. A normal mode exists at times when the engine has reached a normal operating temperature and that is fully warmed up. While the engine operates under the third mode, the pressure regulated valve is at least partially open to allow at least a portion of the flow of coolant fluid returning from the engine to reach the thermostat at step 836. A first thermostat valve is at least partially open to allow a portion of the flow of coolant fluid returning from the engine to enter the radiator at step 838. The third thermostat valve is open to route a portion of the flow of fluid from the radiator to the EGR cooler supply passage at step 840 to the EGR cooler supply passage at step 842 because by now, the coolant temperature should be high, or, the engine has reached a normal operating temperature. The process may be repeated at any time during operation of the engine.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A cooling system for an internal combustion engine, comprising:
a fluid pump having an inlet and an outlet;
a plurality of engine components having a plurality of fluid passages formed therein, wherein the plurality of fluid passages is arranged to receive a flow of coolant therethrough;
a radiator that is operably connected to the internal combustion engine and arranged to cool a flow of coolant passing therethrough;
at least one exhaust gas recirculation (EGR) cooler operably associated with the internal combustion engine;
a fluid controller that fluidly interconnects the fluid pump, the plurality of engine components, the radiator, and the at least one EGR cooler, the fluid controller comprising:
a pressure regulating thermostat (PRT) having a first inlet, a second inlet, and a first outlet;
an EGR mixing valve (EMV) having an additional first inlet, an additional second inlet, and an additional first outlet;
wherein the first inlet and the additional first inlet are selectively connected to the outlet of the fluid pump, wherein the second inlet and the additional second inlet are connected to the radiator, and wherein the outlet and the additional outlet are connected to the inlet of the fluid pump.

2. The cooling system of claim 1, wherein a first path for a flow of cooling fluid is defined between the outlet of the fluid pump, the plurality of fluid passages, the additional first inlet of the EMV valve, the additional outlet of the EMV valve, the at least one EGR cooler, and the inlet of the fluid pump.

3. The cooling system of claim 1, wherein a second path for a flow of cooling fluid is defined between the outlet of the fluid pump, the plurality of fluid passages, the radiator, the additional second inlet of the EMV valve, the additional outlet of the EMV valve, the at least one EGR cooler, and the inlet of the fluid pump.

4. The cooling system of claim 1, wherein a third path for a flow of cooling fluid is defined between the outlet of the fluid pump, the plurality of fluid passages, the first inlet of the PRT, and the inlet of the fluid pump.

5. The cooling system of claim 1, wherein a fourth path for a flow of cooling fluid is defined between the outlet of the fluid pump, the plurality of fluid passages, the radiator, the second inlet of the PRT, and the inlet of the fluid pump.

6. The cooling system of claim 1, wherein the PRT has a pressure-actuated poppet that fluidly blocks the flow of cooling fluid from passing from the plurality of fluid passages into the inlet of the fluid pump at times when a difference in pressure of fluid in the plurality of fluid passages minus a pressure of fluid at the inlet of the fluid pump is less than a predetermined value.

7. The cooling system of claim 1, wherein the PRT includes a first thermostat valve that is controlled by a first thermal actuator that actuates at a first temperature, wherein the EMV includes a second thermostat valve that is controlled by a second thermal actuator that actuates at a second temperature, and wherein the second temperature is less than the first temperature.

8. The cooling system of claim 1, wherein the PRT further comprises a pressure regulated valve that is arranged to block a fluid flow from entering the first inlet.

9. A coolant controller for a cooling system of an internal combustion engine, comprising:
a housing having a pressure regulating thermostat (PRT) portion and an exhaust gas recirculation (EGR) mixing valve (EMV) portion integrated therewith,
the PRT portion comprising:
an inner PRT cavity in fluid communication with an outer PRT cavity,
a first PRT inlet and a second PRT inlet in fluid communication with the inner PRT cavity,
a first PRT outlet in fluid communication with the outer PRT cavity,
a PRT thermal actuator disposed in the inner PRT cavity,
a first PRT valve connected to the PRT thermal actuator and disposed to fluidly block the second PRT inlet,
a PRT linkage connected to a second PRT valve, wherein the second PRT valve is disposed to fluidly block the first PRT inlet;
the EMV portion comprising:
a mixing cavity having a first EMV inlet, a second EMV inlet, and an EMV outlet,
an EMV thermal actuator disposed in the mixing cavity,
an EMV valve connected to the EMV thermal actuator, wherein the EMV valve blocks the second EMV inlet in a closed position.

10. The coolant controller of claim 9, further comprising a distribution cavity having a radiator inlet opening, wherein the distribution cavity is in fluid communication with the second PRT inlet and the second EMV inlet.

11. The coolant controller of claim 9, further comprising an internal gallery volume, wherein the gallery is in fluid communication with the first PRT inlet and the second PRT inlet.

12. The coolant controller of claim 11, further comprising a right cylinder head coolant supply passage in fluid communication with the gallery and a left bank cylinder head coolant supply passage in fluid communication with the gallery.

13. The coolant controller of claim 9, further comprising an EGR cooler supply passage in fluid communication with the EMV outlet.

14. The coolant controller of claim 9, further comprising a pump inlet opening formed in the housing, wherein the pump inlet opening is in fluid communication with the outer PRT cavity.

15. The coolant controller of claim 14, further comprising an EGR cooler return passage formed in the housing, wherein the EGR cooler return passage is in fluid communication with the pump inlet opening.

16. The coolant controller of claim 9, further comprising a temperature sensor connected to the housing and arranged to measure a temperature of a fluid entering the mixing cavity during operation.

17. A method of controlling a flow of coolant through a cooling system for an internal combustion engine, comprising the steps of:
pumping a flow of fluid having an initial temperature and a first pressure through a plurality of engine components;
separating a portion of the flow of cooling fluid depending on a temperature and pressure of the flow of cooling fluid;
operating under a first mode of operation at times when the engine is warming-up and operates close to an idle condition, wherein operation under the first mode comprises the steps of:
routing the portion of the flow of cooling fluid through at least one exhaust gas recirculation (EGR) cooler,
closing a pressure-regulated valve,
closing a first thermostat valve;
operating under a second mode of operation at times when the engine is operating without having fully warmed up and is not close to an idle condition, wherein operation under the second mode comprises the step of:
opening the pressure regulated valve;
closing a second thermostat valve when a temperature of the portion of the flow of cooling fluid is low;
partially opening the second thermostat valve when the temperature of the portion of the flow of cooling fluid is intermediate;
fully opening the second thermostat valve when the temperature of the portion of the flow of cooling fluid is high;
operating under a third mode of operation at times when the engine is fully warmed-up, wherein operation under the third mode comprises the step of opening the first thermostat valve.

18. The method of claim 17, further comprising the step of selectively cooling the portion of the flow of cooling fluid in a radiator while bypassing a remaining portion of the flow of cooling fluid around the radiator.

19. The method of claim 17, further comprising the step of supplying the portion of the flow of cooling fluid to at least one EGR cooler.

20. The method of claim 17, wherein operation under the third mode of operation further comprises the step of passing a remaining portion of the flow of cooling fluid through a radiator.
